(19) United States
(12) Patent Application Publication
(10) Pub. No.: US 2026/0115815 A1
(43) Pub. Date: Apr. 30, 2026

(54) SAW-BAND QUICK REPLACEMENT MECHANISM FOR BANDSAW MACHINE

(71) Applicant: THE KINGCRAFT MACHINERY COMPANY LIMITED, Taichung City (TW)

(72) Inventors: Calvin Chou, Taichung City (TW); Ming-Ta Chou, Taichung City (TW)

(21) Appl. No.: 18/931,497

(22) Filed: Oct. 30, 2024

(51) Int. Cl. B23D 55/06

(52) U.S. Cl. CPC B23D 55/065

(57) ABSTRACT

A saw-band quick replacement mechanism for a bandsaw machine includes an immovable rack, a sliding seat, a support member, and a control device. The immovable rack defines a lift space extending along a first direction. The sliding seat is accommodated in the lift space and configured to move upward and downward. The sliding seat has a bottom formed with a first incline. The support member has a second incline configured to abut against the first incline. The control device includes an eccentric member and a handle. The handle is used to switch the eccentric member between a first position and a second position. In the first position, the support member props up the sliding seat. When being switched from the first position to the second position, the eccentric member makes the support member to move along a second direction perpendicular to the first direction, so the sliding seat moves downward.

### BACKGROUND OF THE INVENTION

### 1. Technical Field

The present disclosure relates to bandsaw machines, and more particularly to a saw-band quick replacement mechanism for a bandsaw machine.

### 2. Description of Related Art:

Bandsaw machines have been extensively used in industrial applications and workplaces. In such a machine, a saw band is a part subject to wear and tear and needs to be replaced regularly. The saw band is usually wound around the driven wheel and the driving wheel of the bandsaw machine and properly tensioned so that when the driven wheel and the driving wheel rotate, the saw band can cut a workpiece.

For replacing the saw band, the distance between the driven wheel and the driving wheel has to be narrowed first to relax the saw band, so that the old saw band can be easily removed and a new one can be installed. In the prior art, adjustment of the distance between the driven wheel and the driving wheel is generally achieved using a slide-based structure. In particular, the upper, driven wheel is fixed to the sliding seat, which is connected to the housing of the machine through a screw and a worker can move the sliding seat upward and downward by rotating the screw to adjust the distance between the driven wheel and the driving wheel.

However, such a conventional approach to adjusting the distance between the driven wheel and the driving wheel has its disadvantages. For example, every time the saw band is to be replaced, the upper, driven wheel has to be lowered significantly to relax the saw band, but it takes long to make the screw lift or lower the sliding seat, which leads to operational inefficiency as well as heavy working burdens and high time costs. Hence, there is a pressing need for improving operational efficiency during replacement of the saw band.

### SUMMARY OF THE INVENTION

To address the foregoing issues, the present disclosure provides a saw-band quick replacement mechanism to be used with a bandsaw machine, wherein rotation of the eccentric member of the control device changes the altitudinal position of the support member propping up the sliding seat, so as to change the distance between the driven wheel and the driving wheel to achieve quick replacement of the saw band.

In one embodiment of the present disclosure, a saw-band quick replacement mechanism for a bandsaw machine comprises an immovable rack, a sliding seat, a support member, a control device. The immovable rack defines a lift space that extends along a first direction. The sliding seat is accommodated in the lift space and configured to move upward and downward along the first direction, wherein the sliding seat has a bottom provided with a first incline. The support member has a second incline that is configured to abut against the first incline. The control device includes a link, an eccentric member, and a handle, in which the link has one end connected to the support member and an opposite end connected to the eccentric member, and the handle is connected to the eccentric member to switch the eccentric member between a first position and a second position, so that when the eccentric member is in the first position, the support member props up the sliding seat, and when the eccentric member is rotatably switched from the first position to the second position, the eccentric member makes the link push the support member to move along a second direction that is perpendicular to the first direction, so that the second incline and the first incline slidingly move with respect to each other to make the sliding seat move downward.

Thereby, the present disclosure uses rotation of the eccentric member to change the position of the support member, thereby changing the altitudinal position of the support member propping up the sliding seat, so as to change the distance between the driven wheel and the driving wheel to achieve quick replacement of the saw band.

### BRIEF DESCRIPTION OF THE DRAWINGS

FIG. 1 is a perspective view of a bandsaw machine according to one embodiment of the present disclosure.

FIG. 2 is a schematic drawing showing the internal structure of the upper mount of FIG. 1, wherein the saw band is tensioned.

FIG. 3 is a schematic drawing showing the internal structure of the upper mount from a different view point, wherein the eccentric member is in the first position.

FIG. 4 is a schematic drawing showing assembly of the immovable rack and the sliding seat in one embodiment of the present disclosure.

FIG. 5 is a schematic drawing showing that the driven wheel moves downward according to one embodiment of the present disclosure, wherein the saw band is relaxed.

FIG. 6 is a schematic drawing showing the internal structure of the upper mount according to FIG. 5, wherein the eccentric member is in the second position.

### DETAILED DESCRIPTION OF THE INVENTION

For further illustrating the basic tenets of the present disclosure, the following description, in conjunction with the accompanying drawings and preferred embodiments, is provided. In addition, for easy understanding and reading of people skilled in the art, components are presented in the drawings with illustrative and schematic structures and sizes and shall by no means limit implementation of the present application. For clarity, components may be partially or completely omitted or depicted with imaginary lines in some drawings.

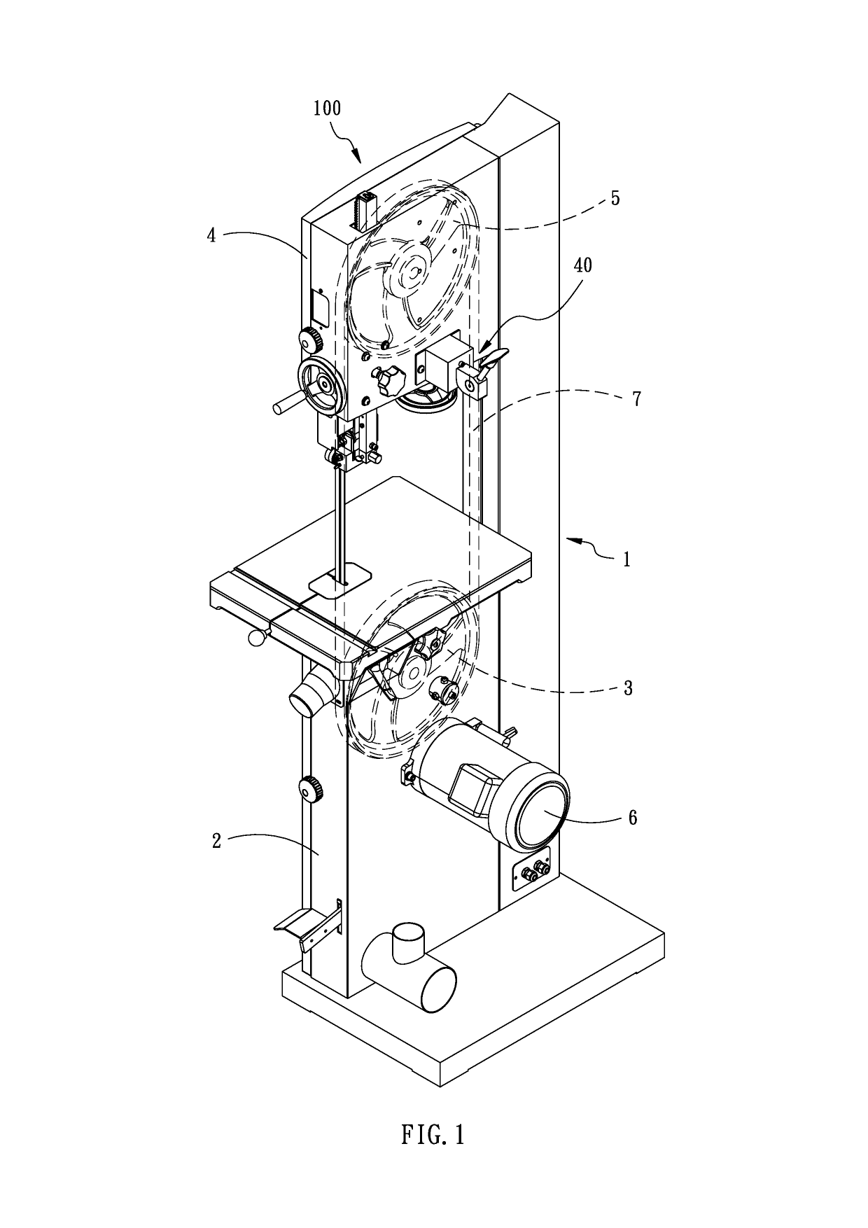

Referring to FIG. 1 through FIG. 6, the present disclosure provides a saw-band quick replacement mechanism 100 to be installed on a bandsaw machine 1. The bandsaw machine 1 comprises a lower mount 2, a driving wheel 3 rotatably installed in the lower mount 2, an upper mount 4 located above the lower mount 2, a driven wheel 5 rotatably installed in the upper mount 4, a motor 6 installed in the lower mount 2 and used to drive the driving wheel 3, and a saw band 7 wound the driving wheel 3 and the driven wheel 5. The saw-band quick replacement mechanism 100 is assembled to the upper mount 4. The saw-band quick replacement mechanism 100 comprises an immovable rack 10, a sliding seat 20, a support member 30, and a control device 40.

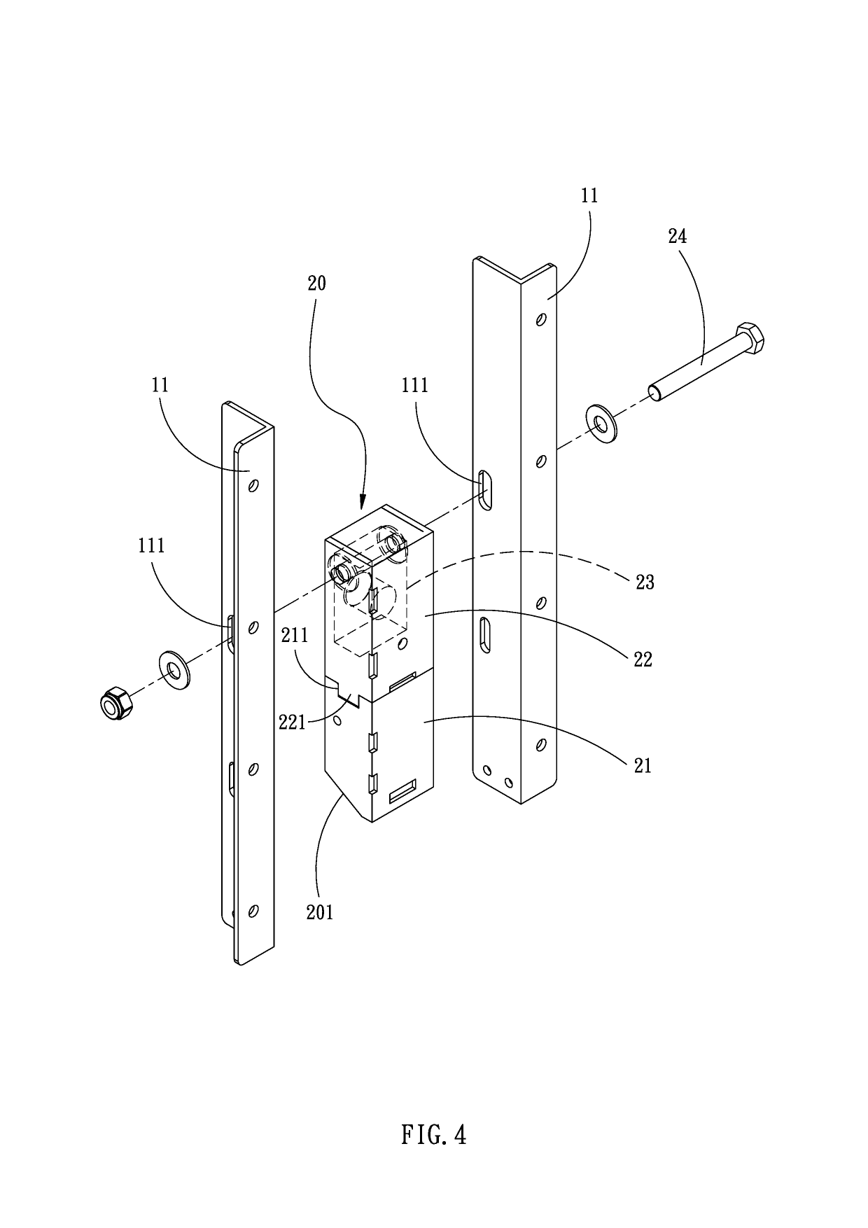

The immovable rack 10 is fixedly installed within the upper mount 4. The immovable rack 10 has two poles 11. The immovable rack 10 defines a lift space 12 extending along a first direction X. The lift space 12 is located between the two poles 11. As shown in FIG. 4, the two poles 11 each has a vertically extending slot 111.

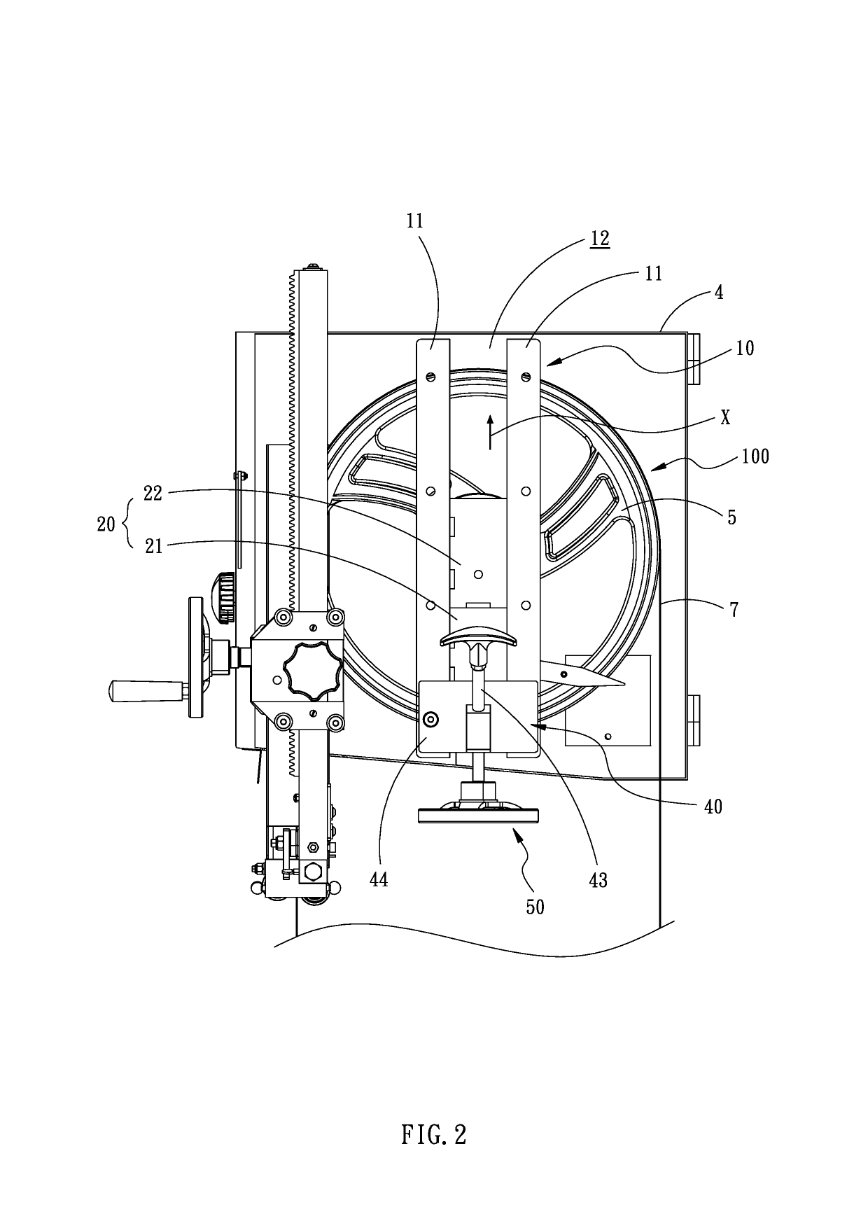

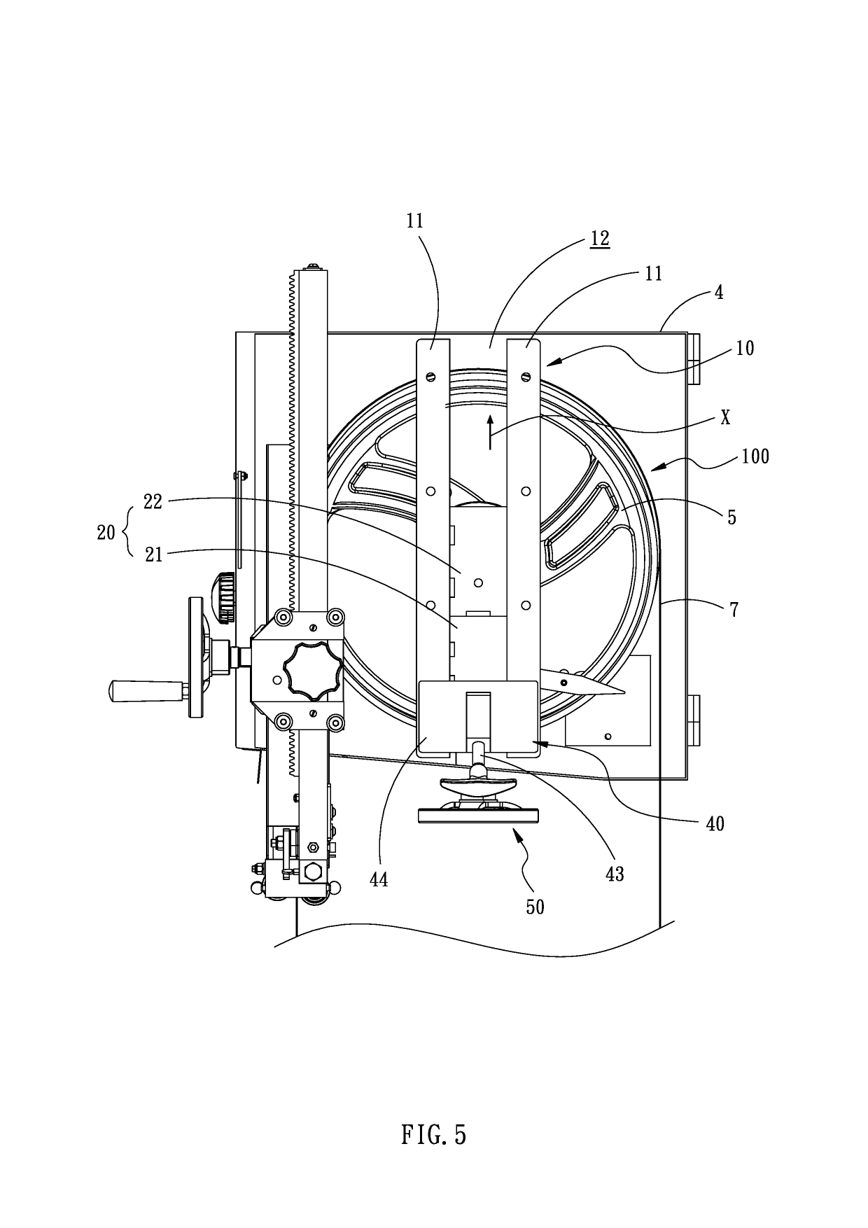

Referring to FIG. 2 through FIG. 4, The sliding seat 20 is accommodated in the lift space 12 and configured to go up and down along the first direction X. The sliding seat 20 has a bottom provided with a first incline 201. The sliding seat 20 has a lower slider 21, an upper slider 22, a coupling member 23, and a connecting shaft 24. The upper slider 22 and the lower slider 21 are each formed as a rectangular hollow body. The upper slider 22 is connected to the lower slider 21 from above. The first incline 201 is formed at the bottom of the lower slider 21. The connecting shaft 24 passes through the upper slider 22 and the coupling member 23 and is hung between the two slots 111, so that the coupling member 23 is suspended in the upper slider 22. Thereby, the upper slider 22 is allowed to slide with respect to the immovable rack 10 within a limited range. Therein, the coupling member 23 is for the driven wheel 5 to be pivotally attached thereon. Therefore, as shown in FIG. 2 or FIG. 5, when the sliding seat 20 moves with respect to the immovable rack 10, the driven wheel 5 is driven to move up or down so as to tension or relax the saw band 7.

In addition, the lower slider 21 has two sides each formed with a socket 211, and the upper slider 22 has two sides each formed with a plug 221, so that the two plugs 221 fit in the two sockets 211, respectively, along the first direction X.

The support member 30 is atop provided with a second incline 31. The second incline 31 abuts against the first incline 201 of the lower slider 21. In the present embodiment, the immovable rack 10 further comprises a floor 13 that is connected between bottoms of the two poles 11. The support member 30 moves with respect to the floor 13 along a second direction Y that is perpendicular to the first direction X, so that the support member 30 can inclinedly support the lower slider 21 from below.

The control device 40 comprises a link 41, an eccentric member 42, a handle 43, and a housing 44. The housing 44 is fixedly installed on the immovable rack 10, so as to house the support member 30. The link 41 has one end connected to the support member 30 and the other end passing through the housing 44 to get connected to the eccentric member 42. The handle 43 is connected to the eccentric member 42. The handle 43 when operated rotationally switches the eccentric member 42 between a first position and a second position.

The eccentric member 42 has a pivot hole 421 and a side slot 422 communicated with the pivot hole 421. The link 41 has a pivotal end 411 that is received in the pivot hole 421. The eccentric member 42 has a first edge 423 and a second edge 424. The distance between the pivot hole 421 and the first edge 423 is greater than the distance between the pivot hole 421 and the second edge 424. In addition, a spring member 45 is provided between the eccentric member 42 and the housing 44. The spring member 45 may be a compression spring.

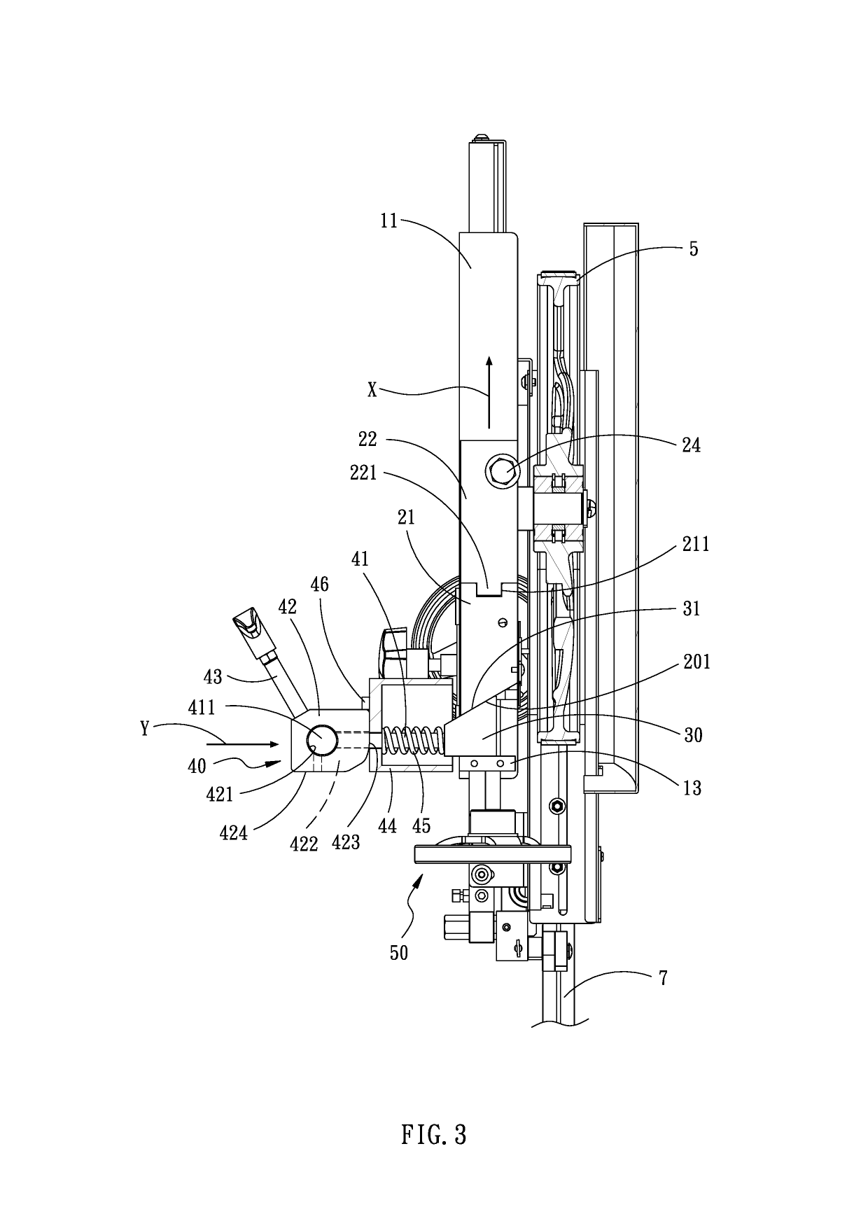

Referring to FIG. 2 and FIG. 3, when the eccentric member 42 is in the first position, the first edge 423 abuts against the housing 44, and the link 41 is located at one end of the side slot 422. The eccentric member 42, through the link 41, pulls the support member 30 to move away from the driven wheel 5, so that the support member 30 props up the sliding seat 20. At this time, the spring member 45 is compressed. In this position, the saw band 7 around the driven wheel 5 is tensed, making sawing operation possible.

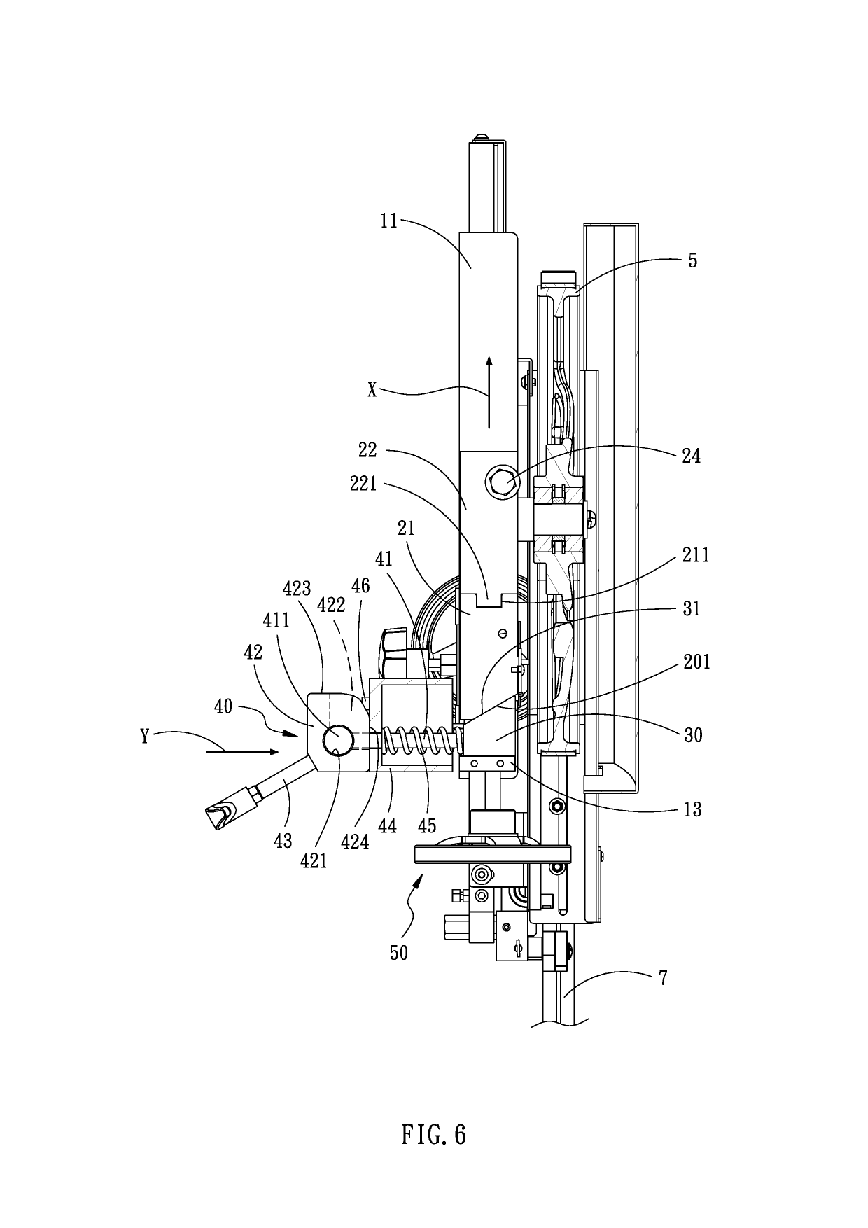

Referring to FIG. 5 and FIG. 6, when a user operates the handle 43 to rotate the eccentric member 42 from the first position to the second position, the eccentric member 42 has its second edge 424 abutting against the housing 44, and the link 41 is located at the other end of the side slot 422. The eccentric member 42 makes the link 41 push the support member 30 to move along the second direction Y, so that the second incline 31 and the first incline 201 slidingly move with respect to each other. Meanwhile, the spring member 45 is relaxed and resiliently returns to its natural state, so that the support member 30 moves toward the driven wheel 5 to draw the sliding seat 20 downward. In this position, the distance between the driven wheel 5 and the driving wheel 3 decreases as the sliding seat 20 moves downward, so the saw band 7 is relaxed for easy removal and replacement of the saw band 7. Therein, the contact area between the second incline 31 and the first incline 201 is larger in the second position than that in the first position.

In the present embodiment, as shown in FIG. 3, the control device 40 comprises a retaining member 46. The retaining member 46 is fixedly installed in the housing 44 and used to such position the eccentric member 42 that the eccentric member 42 leans against the housing 44.

In the present embodiment, for tensioning the saw band 7 properly, a fine adjustment device 50 is provided below the immovable rack 10. The fine adjustment device 50 is used to finely adjust the altitudinal position of the sliding seat 20 by means of screw-based adjustment, thereby adjusting the distance between the driven wheel 5 and the driving wheel 3, and eventually adjusting the tension of the saw band 7.

To sum up, in the present disclosure, adjustment of the altitudinal position of the driven wheel 5 can be achieved quickly by operating the control device 40, and the adjustment leads to change in the tension of the saw band 7, enabling replacement of the saw band 7 to be conducted fast and easily. Meanwhile, the structure of the present disclosure is uncomplex and easy to operate.

The present disclosure has been described with reference to the preferred embodiments and it is understood that the embodiments are not intended to limit the scope of the present disclosure. Moreover, as the contents disclosed herein should be readily understood and can be implemented by a person skilled in the art, all equivalent changes or modifications which do not depart from the concept of the present disclosure should be encompassed by the appended claims.

What is claimed is:

1. A saw-band quick replacement mechanism for a bandsaw machine, the saw-band quick replacement mechanism comprising:
an immovable rack, defining a lift space that extends along a first direction;
a sliding seat, being accommodated in the lift space and configured to move upward and downward along the first direction, wherein the sliding seat has a bottom provided with a first incline;
a support member, having a second incline that is configured to abut against the first incline; and
a control device, including a link, an eccentric member, and a handle, in which the link has one end connected to the support member and an opposite end connected to the eccentric member, and the handle is connected to the eccentric member to switch the eccentric member between a first position and a second position, so that when the eccentric member is in the first position, the support member props up the sliding seat, and when the eccentric member is rotatably switched from the first position to the second position, the eccentric member makes the link push the support member to move along a second direction that is perpendicular to the first direction, so that the second incline and the first incline slidingly move with respect to each other to make the sliding seat move downward.

2. The saw-band quick replacement mechanism of claim 1, wherein the eccentric member has a pivot hole and a side slot communicated with the pivot hole, in which the link has a pivotal end received in the pivot hole, so that when the eccentric member is in the first position, the link is located at one end of the side slot, and when the eccentric member is in the second position, the link is located at an opposite end of the side slot.

3. The saw-band quick replacement mechanism of claim 2, wherein the control device comprises a housing that is fixedly installed on the immovable rack to house the support member, and the link passes through the housing to get connected to the eccentric member, in which a spring member is provided between the eccentric member and the housing, and the eccentric member has a first edge and a second edge, wherein a distance between the pivot hole and the first edge is greater than a distance between the pivot hole and the second edge, so that when the eccentric member is in the first position, the first edge abuts against the housing and the spring member is compressed, and when the eccentric member is in the second position, the second edge abuts against the housing and the spring member is relaxed.

4. The saw-band quick replacement mechanism of claim 3, wherein the control device comprises a retaining member that is fixedly installed in the housing and used to position the eccentric member.

5. The saw-band quick replacement mechanism of claim 2, wherein the sliding seat has a lower slider and an upper slider connected thereto, in which the first incline is formed on the lower slider, and the upper slider is allowed to slide with respect to the immovable rack within a limited range.

6. The saw-band quick replacement mechanism of claim 5, wherein the sliding seat comprises a coupling member and a connecting shaft, and the immovable rack has two poles between which the lift space is defined, in which the two poles are each vertically provided with a slot, the connecting shaft passes through the upper slider and the coupling member and is hung between the two slots, so that the coupling member is suspended in the upper slider.

7. The saw-band quick replacement mechanism of claim 6, wherein the immovable rack further comprises a floor connected between the two poles, and the support member moves with respect to the floor along the second direction.

8. The saw-band quick replacement mechanism of claim 7, wherein the lower slider has two sides each formed with a socket, and the upper slider has two sides each formed with a plug, so that the two plugs fit in the two sockets, respectively, along the first direction.
